(19) United States
(12) Patent Application Publication
(10) Pub. No.: US 2004/0014438 A1
(43) Pub. Date: Jan. 22, 2004

(54) System and method for excluding narrow band noise from a communication channel

(76) Inventor: Abraham Hasarchi, Yavne (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/609,588

(22) Filed: Jul. 1, 2003

Related U.S. Application Data
(63) Continuation-in-part of application No. 10/175,146, filed on Jun. 20, 2002.

(51) Int. Cl. H04B 1/04

(52) U.S. Cl. 455/119

(57) ABSTRACT

In order to adjust a communication channel at a specific frequency, a receiver may receive a signal including the communication channel's frequency band. An analog to digital converter may generate a digital signal correlated to the received signal and the digital signal may be passed through a digital filter configured to pass frequency components at or around the communication channel's frequency band and to exclude components of an interference signal within the communication channel's frequency band. A frequency shifter may shift the frequency of the communication channel's frequency components, either before or after the digital filter. A digital to analog converter may generate an analog signal correlated to the filtered digital signal and a transmitter may retransmit the analog signal.

### RELATED APPLICATIONS

This Patent Application is a Continuation-in-Part of U.S. patent application Ser. No. 10/175,146, filed on Jun. 20, 2002, which is hereby incorporated by reference in its entirety.

### FIELD OF THE INVENTION

The present invention relates generally to the field of communications. More specifically, the present invention relates to digital filtering of a communication channel in order to exclude narrow band noise as well as interferences.

### BACKGROUND

Degradation of signal-to-noise ratio (“SNR”) as well as Bit energy to noise ratio (“Eb/No”) and interference ratio such as Carrier to-interference (“C/I”) ratio occur to a signal carried along a transmission medium (e.g. coax, unshielded conductor, wave guide, open air or even optical fiber or RF over fiber). This degradation and interferences may occur in TDMA and GSM, as well as for new technologies such as: CDMA, EVDO, and WCDM respectively. Signal attenuation and its resulting SNR degradation may limit bandwidth over a transmission medium. Interference from outside signals within the frequency range of a communication channel may also reduc SNR of the channel and reduce the amount of data the channel may carry. In some situations, it may cause a loss of a full frequency channel. Additionally, in some situations, SNR degradation and due to interference signal may render a communication (traffic or control) channel and may even degrade the base station capacity.

In order to improve the SNR of signals being transmitted over long distances, and accordingly to augment the transmission distance and/or data rate, signal repeaters may be placed at intervals along the transmitting path. Repeaters are well known and may be used for optical, microwave and radio frequency (RF) communication systems. Repeaters have been used as part of cellular transmission systems to extend the range of coverage between a cellular base station and a cellular handset.

However, the use of a broadband repeater (pass wide range of operating frequencies) for one or more channels at one or more frequencies within a frequency range of the spectrum (“Operating Band”) (e.g. 800 MHz, 900 MHz, PCS, Public Safety or any other network operating band) may produce noise interference to the network. Furthermore, interference signals present in the vicinity of the repeater, and within the frequency range of one of the communication channels to be repeated, may also be repeated and amplified by the repeater, effectively reducing the SNR of a communication channel to be repeated as well as introducing an interference to the base station receiver that may cause a cell shrink or may lower the base station capacity Turning now to FIG. 1, there is shown a spectral diagram exemplifying the channel frequencies a first cellular operator may be using within the frequency range of the “Operating Band”. Also shown in FIG. 1 is an interference signal, introduced by some outside source, within the frequency range of a second communication channel the first cellular operator. The interference signals may reduce the SNR of one or more communication channels, and the use of a conventional repeater may server to boost the interference signal and reduce the SNR of the communication channel with which it is interfering.

Another scenario (without the use of a repeater) may occur in the outdoor environment. In the outdoor environment there may be interferences that may be in the operating base station receiver (interference signals such as TV station or other cellular operators). These interferences may generate inherences to base station resulting in cell shrink or lower base station capacity. Communication channel having an inference signal, as shown in FIG. 1, may be received by a cellular base station, the interference signal may have adverse effects on the base station receiver. Either the receiver may not be able to extract data from the channel, or in a worst-case situation, the receiver may fully block the receiver traffic or control channel.

An interference signal may be of a fixed nature, having relatively fixed frequencies and amplitudes. Or, an interference signal may be intermittent and of an unstable nature.

There is a need to be able to extract or exclude narrow band noise or interference signals from a communication channel.

### SUMMARY OF THE INVENTION

As part of the present invention, a receiver may receive a signal associated with a certain communication channel at a specific frequency. An analog to digital converter may generate a digital signal correlated to the received signal and the digital signal may be passed through a digital filter configured to filter the digital signal and pass frequency components at or around the frequency of the communication channel's specific frequency. A digital to analog converter may generate an analog signal correlated to the filtered digital signal. In some embodiment of the present invention the analog signal may be passed or input into a base station receiver. In other embodiments of the present invention, a transmitter may retransmit the analog signal either to a base station, a handset or to a repeater.

According to some embodiments of the present invention, there may be included a second digital filter configured to pass frequency components at or around a second frequency associated with a second communication channel.

According to some embodiments of the present invention, there may be included a down-converter to down-convert a received signal to an intermediate signal. An up-converter may also be included to up-convert to a transmission frequency an analog signal correlated to the filtered digital signal.

According to some further embodiments of the present invention, a digital filter may be configured to filter out an interference signal. The digital filter may either be a notch filter or a combination of two filters having partially overlapping band pass characteristics.

According to some further embodiments of the present invention, the digital signal, either before or after filtering, may be mixed with a digital sinusoidal signal at a frequency F_{shift}.

According to some further embodiments of the present invention, an analog signal produced by the digital to analog converter may be provided to the input of a base station receiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a spectral diagram showing four multi-frequency signals which may be used by a cellular operator for four communication channels in a specific geographic region, where the second communication channel is corrupted by an interference signal;

FIG. 2 is a block diagram showing an example of a bi-directional repeater with digital filters and frequency shifters according to some embodiment of the present invention;

FIG. 3 is a block diagram showing one possible embodiment of the filters and frequency shifters block of FIG. 2;

FIGS. 4A to 4D are spectral diagrams showing examples of frequency responses of digital filters 140A through 140D in FIG. 3;

FIG. 4E is a spectral diagram showing a frequency domain representation of a digital sinusoidal signal at frequency Fshift;

FIGS. 4F & 4G are spectral diagrams showing examples of communication channels being frequency shifted;

FIG. 5 is a block diagram showing another example of a bi-directional repeater with digital filters and frequency shifters according to some embodiment of the present invention; and

FIG. 6 is a block diagram showing a communication channel filtering and frequency shifting system according to the present invention placed in front of a base station.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

As part of the present invention, a receiver may receive a signal associated with a certain communication channel at a specific frequency. An analog to digital converter may generate a digital signal correlated to the received signal and the digital signal may be passed through a digital filter configured to filter the digital signal and pass frequency components at or around the frequency of the communication channel's specific frequency. A digital to analog converter may generate an analog signal correlated to the filtered digital signal. In some embodiment of the present invention the analog signal may be passed or input into a base station receiver. In other embodiments of the present invention, a transmitter may retransmit the analog signal either to a base station, a handset or to a repeater.

According to some embodiments of the present invention, there may be included a second digital filter configured to pass frequency components at or around a second frequency associated with a second communication channel.

According to some embodiments of the present invention, there may be included a down-converter to down-convert a received signal to an intermediate signal. An up-converter may also be included to up-convert to a transmission frequency an analog signal correlated to the filtered digital signal.

According to some further embodiments of the present invention, a digital filter may be configured to filter out an interference signal. The digital filter may either be a notch filter or a combination of two filters having partially overlapping band pass characteristics.

According to some further embodiments of the present invention, the digital signal, either before or after filtering, may be mixed with a digital sinusoidal signal at a frequency F_{shift}.

According to some further embodiments of the present invention, an analog signal produced by the digital to analog converter may be provided to the input of a base station receiver.

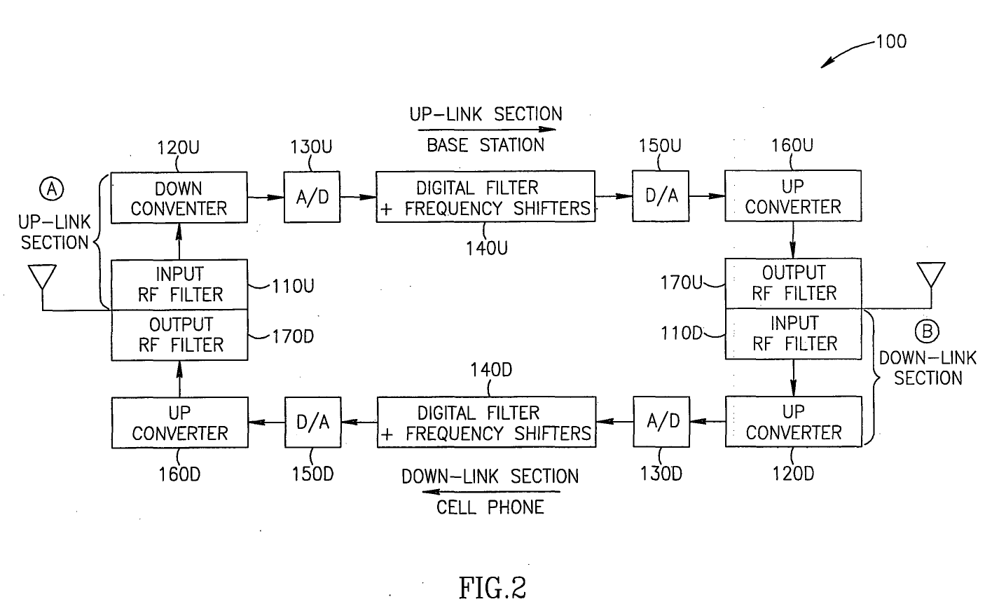

Turning now to FIG. 2, there is shown a block diagram of a bi-directional repeater 100 with a digital filters and frequency shifters block 140U according to the present invention. The bi-directional repeater 100 may include two basic sections: (A) an upstream or up-link section which receives signals from a mobile device (e.g. cell phone) and retransmits the signal to a base-station; and (B) a downstream or down-link section which receives signals from either a base-station or an upstream repeater, and retransmits the signals to a mobile device or to a downstream repeater.

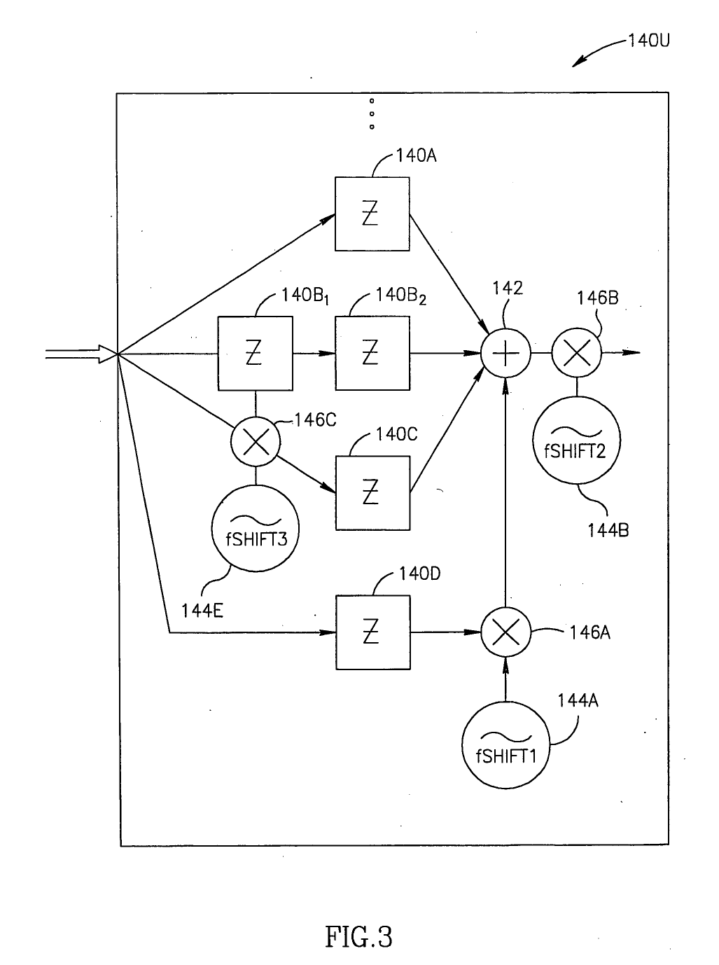

Looking first at the up-link section (A) from left to right on FIG. 2, there may be an input filter 110U, which for this example, may be a radio frequency (“RF”) filter, or more specifically, may be a filter tuned to pass frequencies in the range of an Operating Band, 800 to 830 MHz, for example. The input RF filter 110U may receive signals from an antenna and may pass frequencies in the frequency range of one or more communication channels to be repeated to a down converter 120U. The down converter 120U may mix a received signal with a sine or cosine signal of a given frequency such that the received signal is down-converted to an intermediate frequency (“IF”). Either the input RF filter 110U or the down converter 120U may include a signal amplifier (Not shown in FIG. 2). An analog to digital (“A/D”) converter 130U may sample the IF signal and may generate a digital signal representing the sampled IF signal. The digital signal representing the IF signal may enter digital filter and frequency shifter block 140U. FIG. 3 shows a more detailed view of one embodiment of block 140U, including digital filters 140A to 140D, mixers 146A and 146B, and digital sinusoidal generators 144A and 144B.

Turning now to FIG. 3, there is shown a block diagram of a digital filter and frequency shifter block 140U, including digital filters 140A to 140D, mixers 146A and 146B, and digital sinusoidal generators 144A and 144B. A digital signal entering block 140U may be applied to each of the digital filters 140A through 140D and the output of each of the digital filters may be combined by an adder 142 or by a functionally quivalent device. Each of the filters within the filter bank 140U may have a separate and distinct frequency response. Digital filters are well known in the field of communications. Implementation of a digital filter bank may be performed on a single or multiple processors (e.g. DSP) or may be implemented on a single or multiple dedicated digital filtering circuits (e.g. field programmable digital filters). In the example of FIG. 3, there are shown five discrete digital filter circuits. As part of some embodiment of the present invention, digital filters 140A through 140D may be field programmable digital filters (“FPDF”). That is, each filter's transfer function, along with its frequency response, may be programmed, reprogrammed or adjusted.

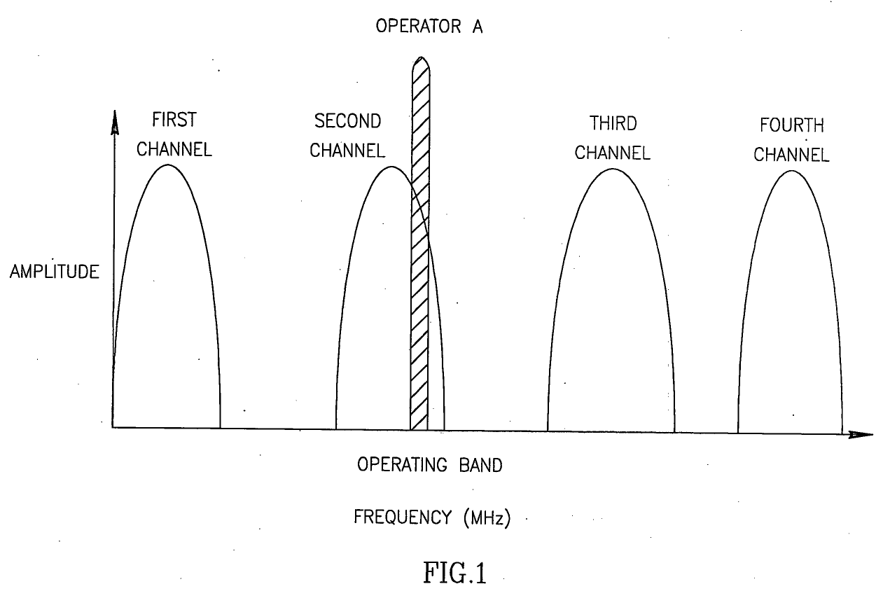

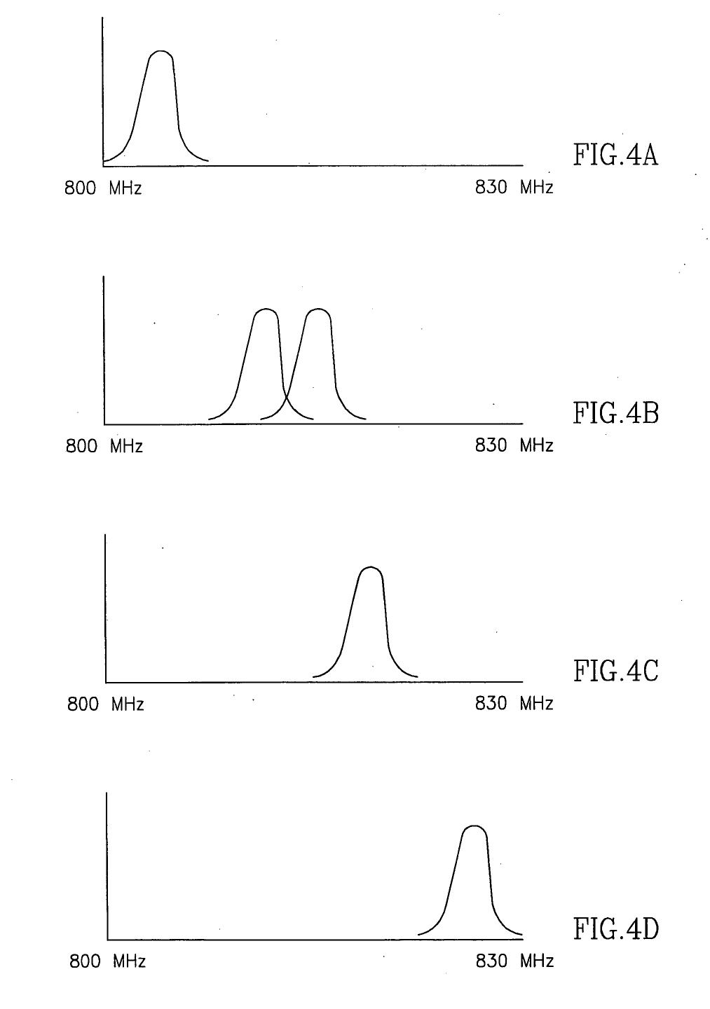

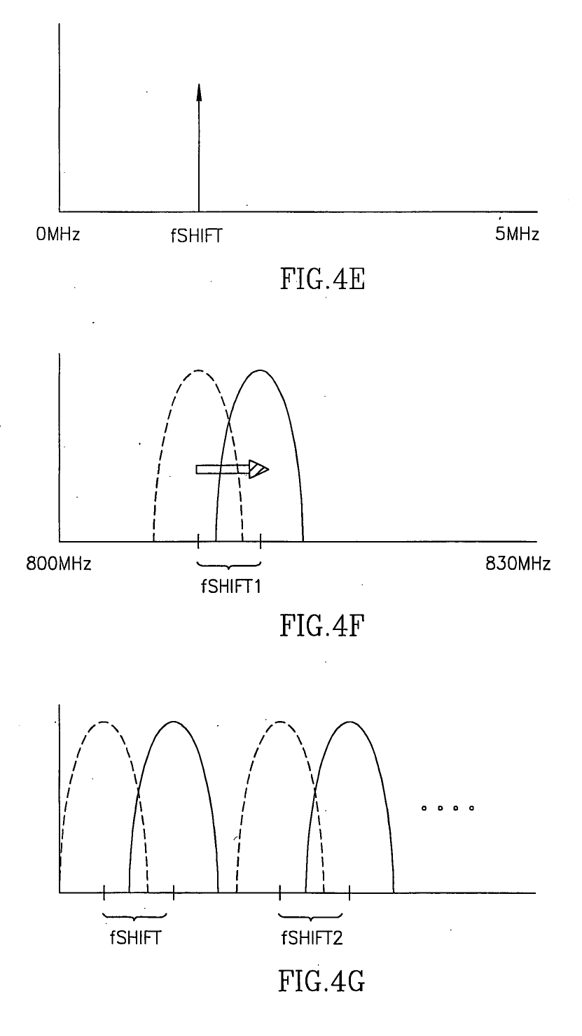

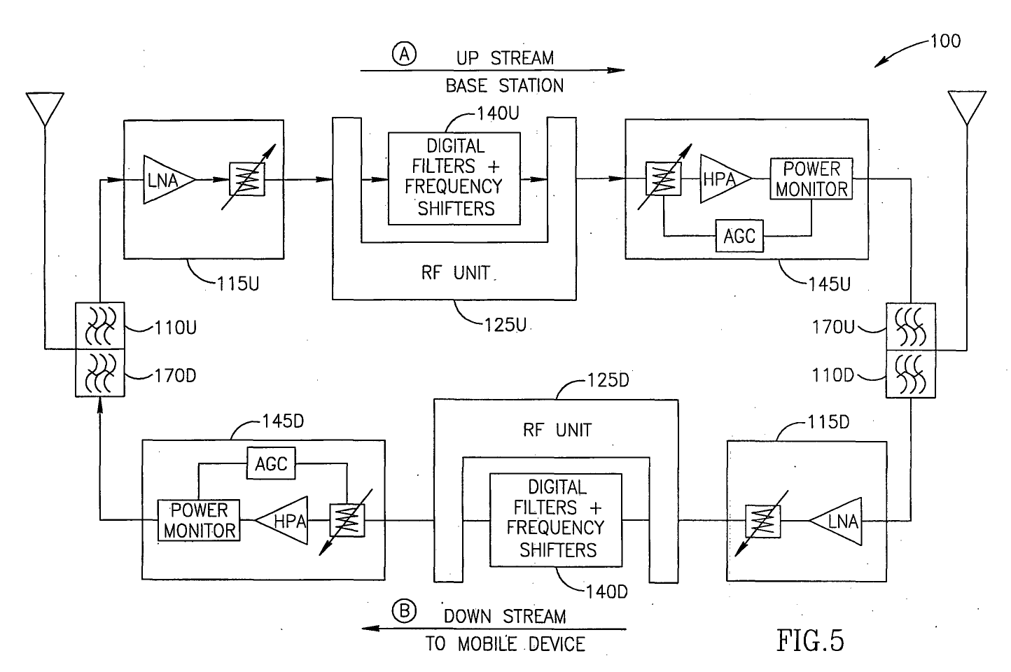

Turning now to FIGS. 4A through 4D, there are shown examples of possible frequency responses for digital filters 140A through 140D of FIG. 3, where digital filters 140A through 140D correspond to the first through the fourth communication channels exemplified in FIG. 1A, respectively. That is, the impulse response or frequency transfer characteristic for each digital filter 140A through 140D may be separately set or adjusted to pass frequency components of digital signals that are at or around the carrier frequency of the filter's corresponding communication channel. For example, digital filter 140A may be programmed with a transfer function having a band pass frequency response peaking at or around the carrier frequency of the first communication channel shown in FIG. 1A; Digital filter 140C may be programmed with a transfer function having a band pass frequency response peaking at or around the carrier frequency of the third communication channel shown in FIG. 1A, etc.

Digital filters 140B₁ and 140B₂ may be arranged in series and each may be programmed to have a partially overlapping band-pass frequency response with the other, as shown in FIG. 4B. An application of the resulting frequency response of the combined filt rs is the exclusion of interference signals such as the one shown in FIG. 1A. If an interference signal is present within a communication channel's frequency band, the filters may be configured to produce a frequency response having two peaks and a low/no pass region, or notch, at or around the frequency of the interference signal. For example, as shown in FIG. 1A, a communication channel (second communication channel) may have frequency components between 808 MHz and 813 MHz, and an interference signal (e.g. television signal from a neighboring country) may have a frequency band of 810 to 811 MHz. The filters 140B₁ and 140B₂ may be configured to produce a frequency response to pass most of the frequency components between 808 MHz and 813 MHz and to exclude or suppress frequency components between 810 to 811 MHz, thereby stopping the interference signal from propagating through the block 140U and being repeated or retransmitted. Numerous filter designs (e.g. a notch filter) may be used to produce a frequency response having the property of passing most of the frequency components of a communication channel and suppressing or excluding frequency components of an interference signal within the frequency band of the communication channel.

The design of digital filters and digital filter transfer functions is well known. Although specific filters and transfer functions are mentioned above, any digital filter and transfer function combination, currently known or to be devised in the future, may be used as part of the present invention. Furthermore, the digital filter or filters may be field programmable digital filters, which are well known in the art, and which may be reprogrammed in response to a shift in the frequency composition of an interference signal. That is, if the frequency band of the interference signal changes, the digital filter or filters may be reprogrammed to shift the low/no pass region to correspond with the interference signal's frequency band. Notch filters performance may be changed to optimize the channel performance. Such optimization of the channel performance may result in, for example, filter bandwidth, attenuation, delay as well as filter slops, providing linear phase, and minimum in/out band delay variation.

Also shown in FIG. 3 are three frequency-shifting units. The first frequency-shifting unit may include a digital sinusoidal signal generator 144A to produce a digital sinusoidal signal at a frequency F_{shift1}, and a digital mixer 146A to mix the digital sinusoidal signal with an output of a digital filter (e.g. digital filter 140D). The second frequency shifter unit may include a digital sinusoidal signal generator 144B to produce a digital sinusoidal signal at a frequency F_{shift2}, and a digital mixer 146B to mix the digital sinusoidal signal with the output of digital signal adder 142. The third frequency shifter unit may include a digital sinusoidal signal generator 144C to produce a digital sinusoidal signal at a frequency F_{shift3}, and a digital mixer 146C to mix the digital sinusoidal signal with an input to a digital filter (e.g. 140C. Signal shifting units may shift the frequency of the signals to which they are applied by the frequency of the digital sinusoidal signal produced by their respective digital sinusoidal generators. FIG. 4E show a spectral diagram of a digital sinusoidal signal, which digital sinusoidal signal appears as an impulse at the frequency of the signal (F_{shift}). FIG. 4F shows a spectral diagram depicting a shift in the frequency components of a single communication channel, as may result from the application of a frequency shifter to the either the input or output of a digital filter 140. FIG. 4G shows a spectral diagram depicting a shift in the frequency components of several communication channels, as may result from the application of a frequency shifter to the output of digital signal adder 142.

Generally, mixing a digital signal with a digital sinusoidal signal server to shift the frequency components of the digital signal by the frequency of the sinusoidal signal. The shift may be both up and down in frequency, and harmonics may also be produced by the process. Thus filters may be used to isolate the desired frequency band. Digital filters may be used to remove harmonics from the output of mixers 146A and 146A.

Now turning back to FIG. 2, there is shown, directly after the digital filter and frequency shifter block 140U, a digital to analog converter (“D/A”) 150U. The D/A 150U may convert the digital signal output of the block 140U to an analog signal, which analog signal may then be up-converted by up-converter 160U to the original frequency which was received at input RF filter 110U. An output filter 170U may be used to remove harmonics which may have been introduced into the signal by the up-converter 160U. Either the up-converter 160U or the output RF filter 170U may include a signal amplifier (not shown in FIG. 2). The filtered signal may then propagate to and out of a transmission antenna.

The downstream or down-link (B) section of the bi-directional repeater 100 may substantially mirror the up-stream section (A) discussed above. A difference being that the input RF filter 110D, digital filters and frequency shift r block 140D and output RF filter 170D may be tuned to receive and pass frequencies of downstream communication channels, as oppos d to passing frequencies at or around upstream communication channels.

The specific frequency bands to which each of the filters is set may depend on the specific frequencies of the communication channels, upstream and downstream, an operator may wish to repeat within a specific geographic location. The frequencies shown in FIG. 1 are only examples of such communication channel frequencies. No distinction is made between upstream and downstream channels in FIG. 1. However, it will be understood by one of ordinary skill in the art that in a cellular system, there may be a corresponding upstream communication channel for each down stream communication channel. The relation between an upstream channel frequency and a downstream channel frequency may be fixed, or each may be negotiated or set separately between a mobile device and a base station.

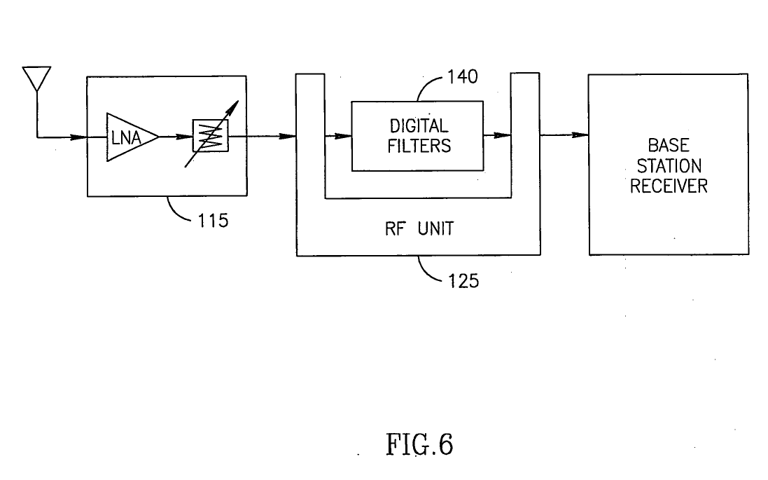

Turning now to FIG. 6, there is shown an embodiment of the present invention suitable as an input stage to a conventional cellular base station, a conventional repeater, or any other communication system with a receiver. In the embodiment shown in FIG. 6, there may be a pre-filtering stage 115 which may include a low noise amplifier (“LNA”) and aftenuator. An RF unit 125 may contain a down converter and may down convert the output of the pre-filtering block to an intermediate frequency. An A/D converter may be included in the RF unit 125 or in a digital filter block 140. The down converted signal may be converted into a digital signal by the A/D, and the digital signal may be filtered by digital filters in the digital filter block 140 as described above (also see FIGS. 3 and 4A-G).

One of ordinary skill in the art should understand that down converting of the analog signal to an intermediate frequency may not be required if an A/D converter having a sufficiently high sampling rate is used. Typically, in order to get an accurate digital representation of an analog signal, a sampling rate of twice the highest frequency component in the analog signal is required. Thus, down converting to an intermediate signal may allow for the use of a slower and cheaper A/D converter, however, it is not essential.

Once a digital signal representing the received analog signal is produced, filtering of interference signals and frequency shifting of communication channels may be performed as describer above with reference to FIGS. 3 and 4A to 4G. The digital filters 140 may be configured to produce any one of a number of transfer characteristics or frequency responses, including notch filtering of a narrow band interference signal.

Once filtered, the digital signal may be converted back to a D/A converter. The output of the D/A may be up converted, if a corresponding down conversion step was used. The D/A may either be part of the filtering block 140 or part of the RF unit 125. The up converter, if used, may be part of the RF unit 125.

The analog output of the above described embodiment of the present invention may be applied to an RF input stage of a conventional base station, as shown in FIG. 6, or to the input stage of a conventional repeater, or to any other receiver used as part of a RF communication system.

Turning now to FIG. 5, there is shown another possible embodiment of a bi-directional repeater 100 according to the present invention. As in the bi-directional repeater of FIG. 2, there are two sections; (A) an upstream or up-link section, and (B) a downstream or down-link section. Also, as in the embodiment of FIG. 2, the up-link and down-link sections may substantially mirror one another except for the frequencies they are tuned to pass and retransmit.

Looking at the downstream or down-link section (B) of the bi-directional repeater 100 of FIG. 5, there may be a duplexer including an input RF filter 110D. The input RF filter 110D may lead to a pre-filtering stage 115D which may include a low noise amplifier (“LNA”) and an attenuator. The output of the pre-filtering block 115D may enter an RF unit 125D which may down convert the output and may also include an A/D converter. Digital filters and frequency shifters in digital block 140D may be similar to the ones described for FIGS. 2, 3 or 4A through 4D, or may be any other digital filters and frequency shifters suitable to the present invention. The output of the digital filter block 140D may enter the RF unit 125D which may up convert the output,and may also include a D/A converter. A power amplifier block 145D may include an attenuator, a high-power amplifier, and a power monitor. An automatic gain control circuit (“AGC”) may adjust the attenuator such that the output signal from the power amplifier block 145D remains substantially steady. The output signal of the power amplifier block 145D may propagate to and through a duplexer including an output filter 170D.

As for the bi-directional repeater 100 in FIG. 2, the bi-directional repeater 100 of FIG. 5 may be configured to repeat specific sets of communication channels, at or around specific carrier frequencies, in the upstream direction, and to repeat specific sets of communication channels, at or around specific carrier frequencies, in the downstream direction. Digital filters and frequency shifters in the digital blocks 140U and 140D, may be adjusted to pass only frequencies at or around the carrier frequencies of the relevant communication channels. Frequency components of one or more communication channels may be shifted using a frequency shifter. Carrier frequency offsets due to up-conversion or down-conversion may be taken into account and compensated for within the digital filters. Furthermore, the bi-directional repeater 100 of the present invention may be adjusted to notch out narrow band noise interference within the communication channels' frequency band.

One of ordinary skill in the art should understand that the described invention may be used for all kinds of wireless or wire system, including but not limited to Tower Mounted Amplifier, wireless, wire, cables or fiber servers where a narrow interference has to be filtered out, phase linearity and filter parameters should be software programmable and when the interference may be in a channel.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of adjusting a communication channel within which there is an interference signal, said method comprising:
receiving a signal including the communication channel's frequency band;
generating a digital signal correlated to the received signal;
filtering the digital signal with a digital filter configured to pass frequency components at or around the communication channel's frequency band and to suppress frequency components of the interference single; and
generating an analog signal correlated to the filtered digital signal.

2. The method according to claim 1, further comprising down-converting the received signal to an intermediate frequency prior to generating a digital signal.

3. The method according to claim 2, further comprising up-converting the analog signal correlated to the filtered digital signal prior to transmitting the analog signal.

4. The method according to claim 1, further comprising filtering the digital signal with a digital filter configured to pass frequency components at or around a second frequency associated with a second communication channel.

5. The method according to claim 4, further comprising combining the digital signals output from each of said filtering steps and generating an analog signal correlated to the combined digital signal.

6. The method according to claim 5, further comprising transmitting the analog signal correlated to the combined digital signal.

7. A system for adjusting a communication channel within which there is an interference signal, said system comprising:
a receiver to receive a signal including the communication channel's frequency band;
an analog to digital converter to generate a digital signal correlated to the received signal;
a digital filter configured to pass frequency components at or around the communication channel's frequency band and to exclude frequency components of the interference signal; and
a digital to analog converter to generate an analog signal correlated to the filtered digital signal.

8. The system according to claim 7, further comprising a down converter to convert the received signal to an intermediate frequency.

9. The system according to claim 8, further comprising an up converter to convert th analog signal correlated to the filtered digital signal to a transmission frequency.

10. The system according to claim 7, further comprising a second digital filter configured to pass frequency components at or around a second frequency associated with a second communication channel.

11. The system according to claim 10, further comprising a summing unit to combine outputs from said first and second digital filters.

12. The system according to claim 7, further comprising a transmitter to transmit the analog signal correlated to the filtered digital signal.

13. A method of adjusting the frequency composition of a communication channel, said method comprising:
receiving a signal including the communication channel's frequency band;
generating a digital signal correlated to the received signal;
mixing the digital signal with a digital sinusoidal signal at a shifting frequency and filtering the mixed digital signal with a digital filter configured to pass frequency components at or around the communication channel's shifted frequency band; and
generating an analog signal correlated to the filtered digital signal.

14. The method according to claim 13, further comprising down-converting the received signal to an intermediate frequency prior to generating a digital signal.

15. The method according to claim 14, further comprising up-converting the analog signal correlated to the filtered digital signal prior to transmitting the analog signal.

16. The method according to claim 13, further comprising filtering the digital signal with a digital filter configured to pass frequency components at or around a second frequency associated with a second communication channel.

17. The method according to claim 16, further comprising combining the digital signals out from each of said filtering steps and generating an analog signal correlated to the combined digital signal.

18. The method according to claim 17, further comprising transmitting the analog signal correlated to the combined digital signal.

19. The method according to claim 13, further comprising transmitting the analog signal correlated to the filtered digital signal.

20. A system for adjusting the frequency composition of a communication channel, said system comprising:
a receiver to receive a signal including the communication channel's frequency band;
an analog to digital converter to generate a digital signal correlated to the received signal;
a frequency shifter to shift frequency components of the digital signal by a shifting frequency;
a digital filter configured to pass frequency components at or around the communication channel's shifted frequency band; and
a digital to analog converter to generate an analog signal correlated to the filtered digital signal.

21. The system according to claim 20, further comprising a down converter to convert the received signal to an intermediate frequency.

22. The system according to claim 21, further comprising an up converter to convert the analog signal correlated to the filtered digital signal to a transmission frequency.

23. The system according to claim 22, further comprising a transmitter to transmit the analog signal correlated to the filtered digital signal.
